(19) United States
(12) Patent Application Publication
(10) Pub. No.: US 2015/0083709 A1
(43) Pub. Date: Mar. 26, 2015

(54) SHAPEABLE HEATING PANEL SYSTEM

(71) Applicant: SOLENO TEXTILES TECHNIQUES INC., Laval (CA)

(72) Inventors: Francois Pepin, Beloeil (CA); Alain Poirier, St-Jean-Sur-Richelieu (CA); Oliver Guy Robert Vermeersch, St-Hyacinthe (CA); Begriche Aldjia, Montreal (CA)

(21) Appl. No.: 14/386,621

(22) PCT Filed: Mar. 25, 2013
(86) PCT No.: PCT/CA2013/050243

§ 371 Date: Sep. 19, 2014

Related U.S. Application Data
(60) Provisional application No. 61/614,776, filed on Mar. 23, 2012.

(51) Int. Cl. H05B 3/34; H01C 17/02

(52) U.S. Cl. CPC H05B 3/342; H01C 17/02
USPC 219/545; 219/541; 219/529; 29/611

(57) ABSTRACT

A heating panel system for producing heat, comprises a heating panel comprising a layer of heating textile, the heating textile layer being made of a non-woven three-dimensional network of non-woven non-electrically conductive synthetic fibers and electrically conductive strands of synthetic fibers or fine metal wires consolidated therewith. A shapeable structural layer laminated to the heating textile layer. Electrodes are conductively secured to the heating textile layer at opposite ends, the wires being adapted to be connected to a power source to form a circuit with the panel of heating circuit to circulate electric power within the heating textile layer. A method for thermo-shaping the panel is also provided.

### FIELD OF THE APPLICATION

The present application relates to a shapeable heating panel system for producing heat, for use in heating applications requiring some panels, for instance in the automotive industry, in construction, furniture, among numerous other possibilities.

### BACKGROUND OF THE ART

It is commonly known to heat surface by passing an electric current through a circuit within surface. However, existing heated surfaces typically comprise wires arranged in coil configurations, to produce the heat. The presence of such wires therefore has a negative impact on the practicality of heating surfaces, for instance by fragility of heating wires and/or the substantial amount of time required for installation thereof.

### SUMMARY OF THE APPLICATION

It is therefore an aim of the present disclosure to provide a shapeable heating panel system for producing heat that addresses issues associated with the prior art.

Therefore, in accordance with the present application, there is provided a heating panel system for producing heat, comprising: a heating panel comprising: a layer of heating textile, the heating textile layer being made of a non-woven three-dimensional network of non-woven non-electrically conductive synthetic fibers and electrically conductive strands of synthetic fibers or fine metal wires consolidated therewith; at least one shapeable structural layer laminated to the heating textile layer; and electrodes conductively secured to the heating textile layer at opposite ends, the wires being adapted to be connected to a power source to form a circuit with the panel of heating circuit to circulate electric power within the heating textile layer.

Further in accordance with the present disclosure, the electrodes are elongated electrodes and extend along opposite side edges of the layer of heating textile.

Still further in accordance with the present disclosure, each said electrode is made of a conductive wire.

Still further in accordance with the present disclosure, the conductive wire of each said electrode is arranged in at least two elongated passes.

Still further in accordance with the present disclosure, each said electrode comprises at least one copper wire.

Still further in accordance with the present disclosure, each said electrode is sewn to the layer of heating textile with a conductive thread.

Still further in accordance with the present disclosure, sheathed wires are connected to the electrodes and adapted to be connected to the power source.

Still further in accordance with the present disclosure, a power source connector is at the free end of the sheathed wires, the power source connector adapted to be releasably connected to the power source.

Still further in accordance with the present disclosure, tacks are secured to the layer of heating textile at ends of the electrodes connected to said sheathed wires.

Still further in accordance with the present disclosure, the layer of heating textile has an intrinsic resistivity ranging from 0.05 to 5.0 Ωm²/kg.

Still further in accordance with the present disclosure, the strands have a length ranging between 2.5 cm and 15.3 cm.

Still further in accordance with the present disclosure, the shapeable structural layer is made of a thermoplastic having a shaping temperature about a maximum temperature of operation of the layer of heating textile.

Still further in accordance with the present disclosure, an insulation layer is positioned between the layer of heating textile and the shapeable structural layer and laminated therewith.

Still further in accordance with the present disclosure, the insulation layer is a foam polymer.

Still further in accordance with the present disclosure, a functional layer is on a side of the layer of heating textile opposite that of the shapeable structural layer, the functional layer being laminated therewith.

Still further in accordance with the present disclosure, the functional layer is a decorative fabric or cloth.

Still further in accordance with the present disclosure, the heating panel has a planar geometry resulting from lamination, and has a post-lamination thermo-shaped geometry.

Further in accordance with the present disclosure, there is provided a method for thermo-shaping a heating panel comprising: obtaining a laminated heating panel comprising at least a layer of heating textile, the heating textile layer being made of a non-woven three-dimensional network of non-woven non-electrically conductive synthetic fibers and electrically conductive strands of synthetic fibers or fine metal wires consolidated therewith, at least one shapeable structural layer laminated to the heating textile layer, and means for circulating electric power in the layer of heating textile to generate heat; maintaining the laminated in a planar state at ambient temperature; heating the laminated heating panel above a predetermined thermo-shaping temperature to thermo-shape the at least one shapeable structural layer to a selected non-planar geometry; and cooling down the laminated heating panel to maintain same in the selected non-planar geometry.

Still further in accordance with the present disclosure, the heating textile layer is connected to a power source and circulating electric power therein to generate heat to a maximum temperature of operation below the thermo-shaping temperature.

### BRIEF DESCRIPTION OF THE DRAWINGS

FIG. 1 is a block diagram of a shapeable heating panel system for producing heat in accordance with an embodiment of the present disclosure;

FIG. 2 is a schematic view of a heating textile of the textile system of FIG. 1; and

FIG. 3 is a sectional view of a shapeable heating panel of the heating panel system of FIG. 1.

### DESCRIPTION OF THE PREFERRED EMBODIMENTS

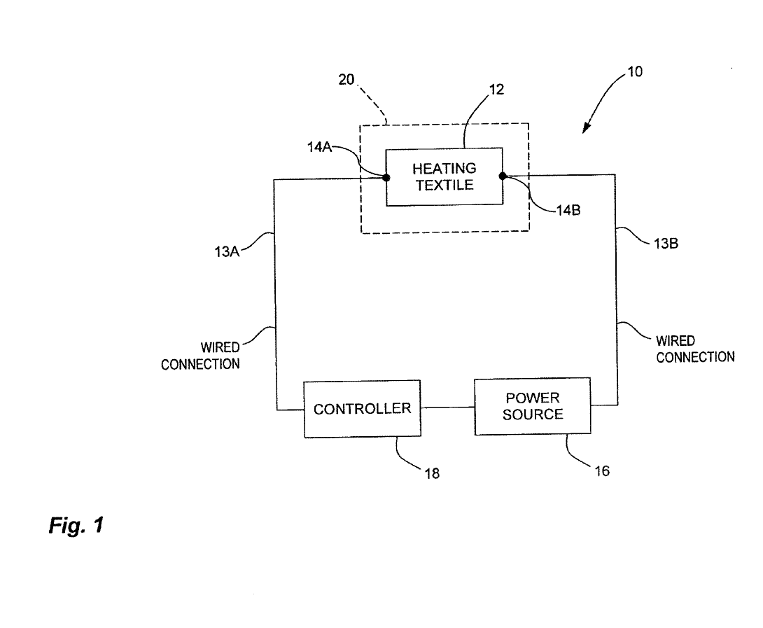

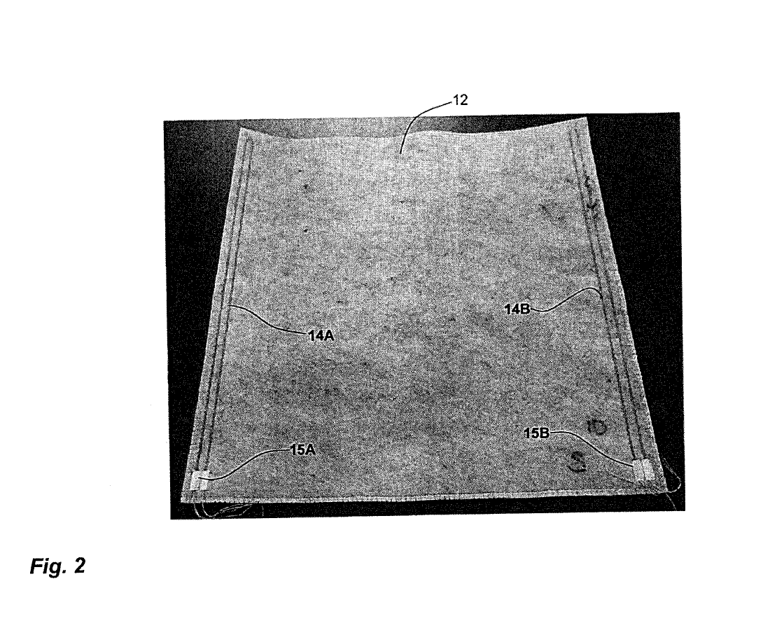

Referring to FIGS. 1 and 2, there is illustrated a heating panel system for producing heat at 10. The heating panel system 10 comprises a shapeable heating panel 12 comprising a layer 12A of heating textile. The heating textile layer 12A of the shapeable heating panel 12 is of the type receiving an electric current to produce heat.

According to an embodiment, the heating textile layer 12A is in accordance with the fabric described in U.S. Pat. No. 7,994,080, incorporated herewith by reference, or in accordance with any other suitable configuration. Therefore, the heating textile layer 12A may be an electrically conductive non-woven fabric comprising a three-dimensional network of non-woven non-electrically conductive synthetic fibers and electrically conductive strands of synthetic fibers or fine metal wires consolidated therewith. The conductive strands may have a length ranging between 1 to 6 inches (2.5 cm to 15.3 cm), although the conductive strands may be longer. According to an embodiment, the non-electrically conductive synthetic fibers occupying a mass ranging between 50% to 98% of the fabric such that the fabric has an intrinsic resistivity in the range of from about 0.05 to 5 Ω m²kg. In this embodiment, the electric current is conducted through the panel of heating textile layer 12A without a circuit of wires all over the textile layer 12A. In other words, the heating textile layer 12A is the link between electrodes 14A and 14B, as described hereinafter. Accordingly, the properties of the heating textile layer 12A are similar to that of more conventional fabrics in terms of lightness and flexibility, thereby facilitating their lamination structural layers.

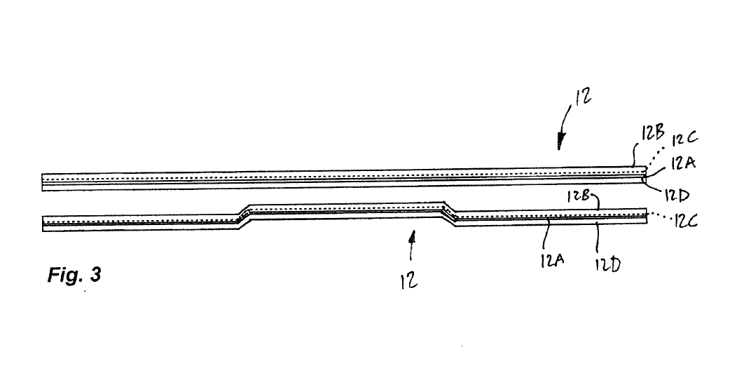

Referring to FIGS. 1 and 3, the shapeable heating panel 12 may comprise at least one structural layer 12B. An additional layer is illustrated at 12C, thereby sandwiching the heating textile layer 12A between structural layers 12B and 12C. The layers 12A, 12B, 12C and/or 12D are therefore laminated together to form the shapeable heating panel 12, shown as thermo-shaped by 12′ in FIG. 3.

At least one of the structural layers 12B and 12C are made of a thermoplastic shapeable material such as polymers, composite materials, metals, etc, upon reaching a given specific heating temperature but maintaining its thermoformed shape at ambient temperatures. The specific heating temperature is thus selected to be below the temperature reached by the powering of the heating textile layer 12A, such that the heating textile layer 12A may generate heat without risking to deform the structural layer 12B, unless a suitable insulation layer is provided as described below. According to an embodiment, the material of the structural layer 12B is selected to substantially maintain its shape when heated, thermoformed or molded, and may hence be a thermoplastic. A well-suited material to be used as structural layer 12B is PVC, although other materials may be used as well. While the heating textile layer 12A, the structural layers 12B and 12C provide a different functionality to the heating panel 12, such as structural integrity allowing the heating panel 12 to be shaped in accordance with the expected use of the heating panel 12.

It is considered for instance to position an additional insulation layer 12D between the structural layer 12B and the heating textile layer 12A, such as a foam polymer. Accordingly, the laminated panel having the heating textile layer 12A, the structural layer 12B and the insulation layer therebetween would have structural integrity due to the presence of the structural layer 12B giving and maintaining a shape for the assembly (e.g., by way of thermoforming), with the heat generated by the heating textile layer 12A being shield from transferring to the structural layer 12B by way of the insulation material 12D. Additional layers may also be used. For instance, the layer 12C may consist of an insulation material (e.g., foam polymers, such as EPP, EPE, EPS) for heat generated by the layer 12A to warm up the structural layer 12B and/or a cushioning material. The layer 12C may otherwise be provided to protect the heating textile layer 12A, and provide a given finish to the heating panel 12, such as leather, vinyl, leather cloth, fabrics, or other decorative cloth layers.

The structural layers 12B, 12C and/or 12D may be laminated to the heating textile layer 12A by any appropriate means and/or process. For instance, an adhesive may be used. The layers may be fused to one another by heating any one of the layers to a sufficient temperature. The layers may be molded to one another, thermoformed into the panel 12, etc.

Hence, the heating panel 12 is thermo-shapeable and is typically provided as a planar panel that may readily be shaped to the appropriate geometry in a post-lamination thermoforming or thermo-shaping. The configuration of the heating textile panel 12A, namely an electrically conductive non-woven fabric comprising a three-dimensional network of non-woven non-electrically conductive synthetic fibers and electrically conductive strands of synthetic fibers or fine metal wires consolidated therewith, is well suited to be a part of the laminated heating panel 12 due to its non woven nature. Indeed, as opposed to woven fabrics, or metallic mesh, a non-woven fabric is more compliant during the post-lamination thermo-shaping process.

Wires 13A and 13B are part of a circuit that will supply electric current to the heating textile layer 12A. As shown in FIG. 2, a portion of the wires 13A and 13B are fixed directly to the heating textile layer 12A, at opposed ends of the panel, and hence form electrodes 14A and 14B for the heating textile layer 12A. The electrodes 14A and 14B are for instance sewn to the heating textile layer 12A in the illustrated elongated pattern. In an embodiment, a conductive sewing thread (e.g., silver or the like) is used to attach the electrodes 14A and 14B to the heating textile layer 12A. The electrodes 14A and 14B may consist of any suitable conducting material, such as a copper wire, and may be arranged in a few passes (two in FIG. 2) to have suitable conducting surface with the heating textile layer 12A. The spacing between the electrodes 14A and 14B causes the electric current to pass through the heating textile layer 12A when the circuit is closed. The resistivity of the heating textile layer 12A will cause same to heat up when electric current passes through it. In parallel, the layers 12B and 12C may be selected with insulating properties to ensure that the current remains in the heating textile layer 12A.

As shown in FIG. 2, tacks 15A and 15B may respectively be provided in the wires 14A and 14B, to secure wires 14A and 14B to the heating textile layer 12A. The electrodes 14A and 14B may be directly linked to the panel of heating textile layer 12A. The tacks 15 are patches of material sewn to the heating textile layer 12A, to reinforce the joint between the electrodes 14A and 14B and the heating textile layer 12A. The wires 13A and 13B may be sheathed from the tacks 15A and 15B to a power source 16. The electrodes 14A and 14B may be directly linked to the panel of heating textile layer 12A, and may also be covered by a strip of sheathing, or encapsulated for instance by folded edges of the heating textile layer 12A.

Referring to FIG. 1, a power source 16 is in the circuit of the system 10. Considering that the textile system 10 is used in heating applications of various apparatuses, the power source 16 may be associated with the apparatus hosting the heating panel 12. For instance, when the heating panel 12 is part of a vehicle (e.g., car, snowmobile, plane), the power source 16 is typically that of the vehicle. In appliances, such as a coffee machine, the power source 16 is typically that of the appliance. Appropriate connectors and signal treating components may provided as a function of the type of battery used. It is also considered to provide the system 10 with a connector plug, such as car lighter connector. A controller 18 may be provided to adjust the level of current fed to the circuit. In its basic configuration, the controller 18 is an on/off switch to open and close the circuit. The controller 18 may be a rheostat, and may include a digital-display thermostat and thermocouple to control the temperature of the heating textile layer 12A. The controller 18 may be that of the apparatus, with an appropriate application in the controller 18 to control the amount of heat produced by the heating panel 12.

The shapeable heating panel 12 may be used in any application requiring a heating panel. The shapeable heating panel 12 may be part of the body of a vehicle (e.g., aircraft, truck, car, train), and may be used to remove ice or snow buildups. In such a case, the heating panel 12 may be connected to the power source from the vehicle. Other automotive applications are considered, for instance, such as heated car mats or heated seating. Moreover, some components of the motor group may be warmed up in cold weather using the heating panel 12.

According to another application, the shapeable heating panel 12 is used as a building material. For instance, the heating panel 12 may be used in roofing, and hence as a de-icing component of the roof. The heating panel 12 may also be part of a radiant heated floor.

According to yet another application, the shapeable heating panel 12 is a part of a mold, with the heating used in the ejection of the molded part after the molding process.

According to yet another application, the shapeable heating panel 12 is a part of dishes that may be heated to keep foodstuff warm.

Hence, a method of operation would go as follows. The heating panel 12 is in a planar state at ambient temperature, following lamination. The laminated heating panel is then heated post-lamination above a predetermined thermo-shaping temperature to thermo-shape the structural layer 12B and other thermo-shapeable layers to a selected non-planar geometry. Other steps including cutting, painting, coloring, etc, the panel beforehand or after thermo-shaping. Once, thermo-shaped, the laminated heating panel is cooled down to maintain same in the selected non-planar geometry. The heating panel 12 may be connect to a power source, for electric power to circulate therein to generate heat. However, the heating panel 12 must have a maximum temperature of operation below the thermo-shaping temperature.

1. A heating panel system for producing heat, comprising:
a heating panel comprising:
a layer of heating textile, the heating textile layer being made of a non-woven three-dimensional network of non-woven non-electrically conductive synthetic fibers and electrically conductive strands of synthetic fibers or fine metal wires consolidated therewith;
at least one structural layer laminated to a first side of the heating textile layer
at least a functional layer secured to a second side of the heating textile layer opposite that of the structural layer; and
electrodes conductively secured to the heating textile layer at opposite ends, the wires being adapted to be connected to a power source to form a circuit with the panel of heating circuit to circulate electric power within the heating textile layer.

2. The heating panel system according to claim 1, wherein the electrodes are elongated electrodes and extend along opposite side edges of the layer of heating textile.

3. The heating panel system according to claim 1, and wherein each said electrode is made of a conductive wire.

4. The heating panel system according to claim 3, wherein the conductive wire of each said electrode is arranged in at least two elongated passes.

5. The heating panel system according to claim 1, wherein each said electrode comprises at least one copper wire.

6. The heating panel system according to claim 1, wherein each said electrode is sewn to the layer of heating textile with a conductive thread.

7. The heating panel system according to claim 1, further comprising sheathed wires connected to the electrodes and adapted to be connected to the power source.

8. The heating panel system according to claim 7, further comprising a power source connector at the free end of the sheathed wires, the power source connector adapted to be releasably connected to the power source.

9. The heating panel system according to claim 7, further comprising tacks secured to the layer of heating textile at ends of the electrodes connected to said sheathed wires.

10. The heating panel system according to claim 1, wherein the layer of heating textile has an intrinsic resistivity ranging from 0.05 to 5.0 Ωm²kg.

11. The heating panel system according to claim 1, wherein the strands have a length ranging between 2.5 cm and 15.3 cm.

12. The heating panel system according to claim 1, wherein the structural layers is made of a molded plastic having a shaping temperature above a maximum temperature of operation of the layer of heating textile.

13. The heating panel system according to claim 1, further comprising an insulation layer positioned between the layer of heating textile and the structural layer and laminated therewith.

14. The heating panel system according to claim 13, wherein the insulation layer is a foam polymer.

15. The heating panel system according to claim 1, wherein the functional layer is a leather panel.

16. The heating panel system according to claim 15, wherein the functional layer is a decorative fabric or cloth.

17. The heating panel system according to claim 1, wherein the heating panel has a planar geometry resulting from lamination, and has a post-lamination thermo-shaped geometry.

18. A method for thermo-shaping a heating panel comprising:
obtaining a laminated heating panel comprising at least a layer of heating textile, the heating textile layer being made of a non-woven three-dimensional network of non-woven non-electrically conductive synthetic fibers and electrically conductive strands of synthetic fibers or fine metal wires consolidated therewith, at least one shapeable structural layer laminated to the heating textile layer, and means for circulating electric power in the layer of heating textile to generate heat;
maintaining the laminated in a planar state at ambient temperature;
heating the laminated heating panel above a predetermined thermo-shaping temperature to thermo-shape the at least one shapeable structural layer to a selected non-planar geometry; and
cooling down the laminated heating panel to maintain same in the selected non-planar geometry.

19. The method according to claim 18, further comprising connecting the heating textile layer to a power source and circulating electric power therein to generate heat to a maximum temperature of operation below the thermo-shaping temperature.
